(19) United States
(12) Patent Application Publication
(10) Pub. No.: US 2016/0261459 A1
(43) Pub. Date: Sep. 8, 2016

(54) PACKAGE DEPENDENCY MAPS FOR DISTRIBUTED COMPUTING

(71) Applicant: HEWLETT-PACKARD DEVELOPMENT COMPANY, L.P., Houston, TX (US)

(72) Inventors: Harish B Kamath, Bengalooru (IN); Sunil Samuel, Bangalore (IN); Aravind Badiger, Bangalore (IN); Prashant B Nayak, Bangalore (IN)

(21) Appl. No.: 15/028,689

(22) PCT Filed: Oct. 14, 2013
(86) PCT No.: PCT/US13/64893

§ 371 Date: Apr. 11, 2016

(51) Int. Cl. H04L 12/24; G06F 3/0484; G06F 3/0482; G06T 11/20; H04L 29/08; G06F 9/445

(52) U.S. Cl. CPC H04L 41/082; H04L 67/10; H04L 67/34; G06F 8/60; G06F 3/0482; G06T 11/206; G06F 3/04845

(57) ABSTRACT

Example embodiments relate to providing package dependency maps for distributed computing. In example embodiments, a dependency map is obtained that includes software packages, where each software package is associated with a site and a distributed node of a distributed system. In response to a user selection of a target package in the dependency map, a referenced subset on which the target package depends and a dependent subset that depend on the target package are determined. At this stage, a display of the dependency map is updated to include the target package, the referenced subset, and the dependent subset in a graphical hierarchy.

### BACKGROUND

Packages develop enclosures to software applications with a set of high availability rules that define where and when to run the software applications to satisfy the high availability rules. A package can have several dependencies that can be described in a hierarchical order. Complexity further compounds if a package is dependent with other packages configured in a clustered environment. For example, a cyclic configuration of dependent packages can cause undesirable effect in a distributed system if not addressed during the configuration phase. Typically, textual representations of package hierarchies are used to configure the dependencies and rules in infrastructure monitoring tools.

### BRIEF DESCRIPTION OF THE DRAWINGS

The following detailed description references the drawings, wherein:

FIG. 1 is a block diagram of an example system for providing package dependency maps for distributed computing;

FIG. 2 is a block diagram of an example computing device including modules for providing package dependency maps for distributed computing;

FIG. 3 is a flowchart of an example method for execution by a computing device for providing package dependency maps for distributed computing;

FIG. 4 is a flowchart of an example method for execution by a computing device for displaying and updating a software dependency map for distributed computing; and

FIG. 5 is a block diagram of an example user interface for displaying a software dependency map for distributed computing.

### DETAILED DESCRIPTION

As discussed above, package dependencies in a clustered environment can be difficult to express, especially if a cyclic configuration of dependent packages causes undesirable effects during the configuration phase. Managing and administering distributed systems can become particularly unwieldy as the number of software packages increases. Software packages may be configured to provide data and control dependencies across the packages. Properly monitoring such dependencies during configuration, deployment, and production of a distributed system allows administrators to ensure that the packages remain operational and to address scheduling configuration requirements.

Example embodiments disclosed herein provide package dependency maps for distributed computing. For example, in some embodiments, a dependency map is obtained that includes software packages, where each software package is associated with a site and a distributed node of a distributed system. In response to a user selection of a target package in the dependency map, a referenced subset on which the target package depends and a dependent subset that depends on the target package are determined. At this stage, a display of the dependency map is updated to include the target package, the referenced subset, and the dependent subset in a graphical hierarchy.

In this manner, example embodiments disclosed herein graphically visualize software package dependencies in a hierarchical format. Specifically, by providing dependency maps that hierarchically and graphically show the dependencies between software packages, configuration of the packages in a distributed environment is facilitated by allowing the administrator to quickly identify dependency conflicts.

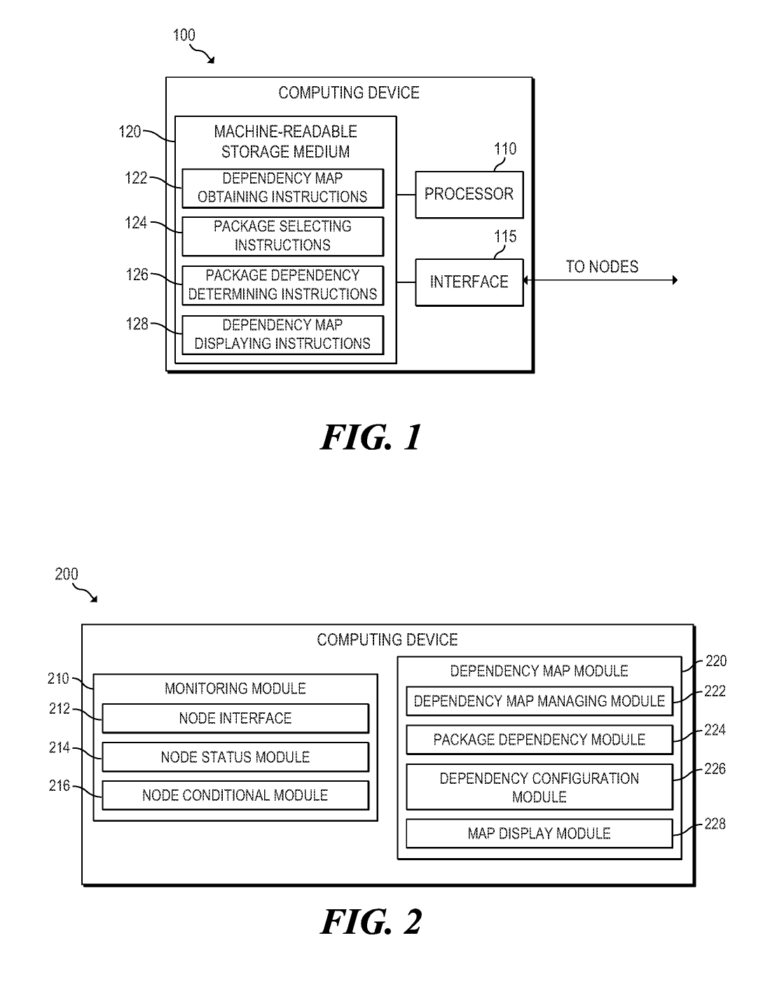

Referring now to the drawings, FIG. 1 is a block diagram of an example computing device 100 for providing package dependency maps for distributed computing. The computing device 100 can include a processor 110 such as a processing unit in a notebook computer, a desktop computer, an all-in-one system, a tablet computing device; multiple computing devices in a distributed system; or any other electronic device suitable for providing package dependency maps for distributed computing. In the embodiment of FIG. 1, computing device 100 may also include an interface 115 and a machine-readable storage medium 120.

Processor 110 may be one or more central processing units (CPUs), microprocessors, and/or other hardware devices suitable for retrieval and execution of instructions stored in machine-readable storage medium 120. In some cases, processor 110 may include multiple CPUs that are distributed across multiple computing devices. Processor 110 may fetch, decode, and execute instructions 122, 124, 126, 128 to enable providing package dependency maps for distributed computing. As an alternative or in addition to retrieving and executing instructions, processor 110 may include one or more electronic circuits including a number of electronic components for performing the functionality of one or more of instructions 122, 124, 126, 128.

Interface 115 may include a number of electronic components for communicating with other computing devices in the distributed system. For example, interface 115 may be an Ethernet interface, a Universal Serial Bus (USB) interface, an IEEE 1394 (FireWire) interface, an external Serial Advanced Technology Attachment (eSATA) interface, or any other physical connection interface suitable for communication with a client device. Alternatively, interface 115 may be a wireless interface, such as a wireless local area network (WLAN) interface or a near-field communication (NFC) interface. In operation, as detailed below, interface 115 may be used to send and receive data, such as dependency data and status data, to and from corresponding interfaces of other computing devices in the distributed system.

Machine-readable storage medium 120 may be any electronic, magnetic, optical, multiple storage devices in a distributed system, or other physical storage device that stores executable instructions. Thus, machine-readable storage medium 120 may be, for example, Random Access Memory (RAM), an Electrically-Erasable Programmable Read-Only Memory (EEPROM), a storage drive, an optical disc, and the like. As described in detail below, machine-readable storage medium 120 may be encoded with executable instructions for providing package dependency maps for distributed computing. In some cases, the storage device that stores executable instructions. Thus, machine 120 may be accessible as a cloud resource, where an installation package including the executable instructions or output of the executable instructions may be obtained and used by processor 110.

Dependency map obtaining instructions 122 may obtain a dependency map for software packages in a distributed system. For example, a dependency map may be obtained from an application or module configured to automatically generate dependency maps for software packages. In another example, the dependency map may be generated manually by an administrator for use by processor 110. A software package defines an enclosure to a software application with a set of high availability rules. Rules may describe where and when to run the software application to satisfy the high availability requirements. A dependency map may be a graphical presentation of software packages within the hierarchy of a distributed system. Specifically, the dependency map may show dependencies between and locations of software packages within the distributed system. A dependency of a software package may describe a reliance on modules or services of a related software package. For example, a software package may rely on an application programming interface (API) of a related software package to perform requested operations. In this example, the software package may be inactivated if the related software package is unavailable.

Package selecting instructions 124 may process user interface selections performed by an administrator. For example, the administrator may select a software package from a list of related software packages to request a dependency map. In this example, the request may be processed to determine parameters for generating the dependency map of the software package. The parameters may include, but are not limited to, a package identifier, a node identifier that identifies the node on which the software package is installed, a map format that describes the layout and information to be included in the dependency map, etc.

Package dependency determining instructions 126 may identify dependent packages and referenced packages of the software package for the requested dependency map. A dependent package is a package that relies on functionality in the software package. A referenced package is a package that provides functionality that is used by the software package. For example, the dependent and referenced packages may be identified by using the package identifier to query a lookup table that includes data records describing dependencies between software packages. The dependent and referenced packages may be collectively referred to as the dependency requirements of the software package.

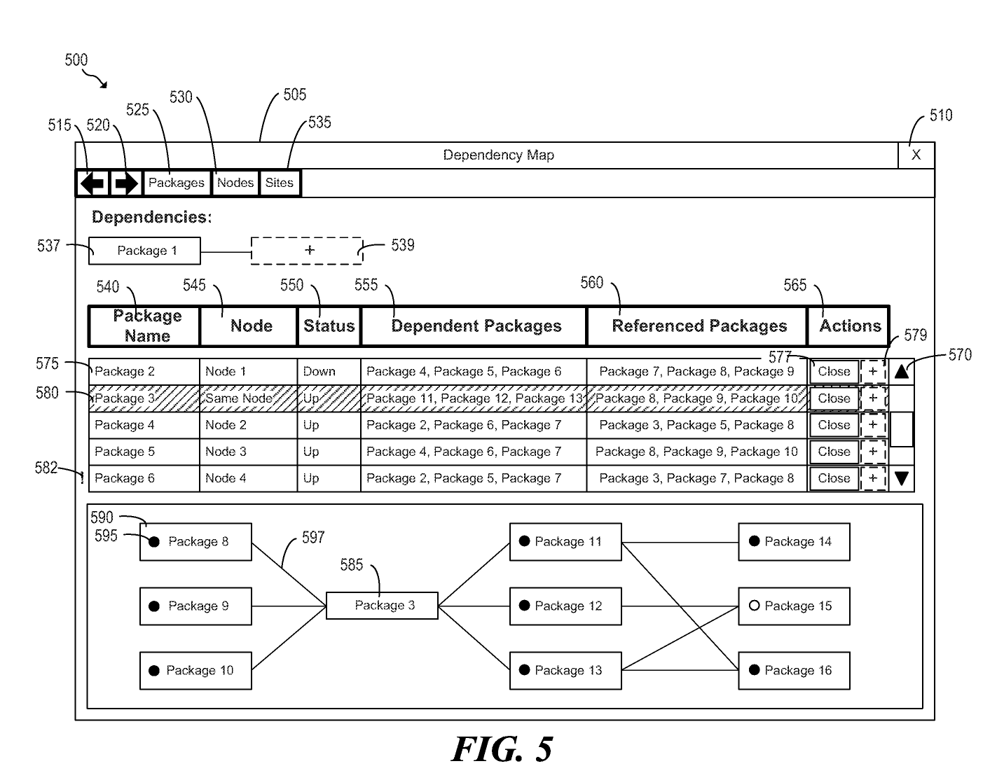

Dependency map display instructions 128 may render the dependency map for displaying on a display device (not shown). For example, the dependency map may be rendered as described with respect to FIG. 5 below. The rendering of the dependency map may include a graphical hierarchy that shows the dependencies between software packages in the distributed system. In some cases, the rendering may also include other information related to the software packages such as status information (e.g., availability), node information, etc. The administrator may use the dependency map to reconfigure the distributed system by, for example, resolving conflicts between software packages.

FIG. 2 is a block diagram of an example computing device 200 including modules for providing package dependency maps for distributed computing. As with processor 110 of FIG. 1, computing device 200 may be any electronic device suitable for providing dependency maps.

As illustrated in FIG. 2 and described in detail below, computing device 200 may also include a number of modules 210-228. Each of the modules may include a series of instructions encoded on a machine-readable storage medium and executable by a processor (not shown) of computing device 200. In addition or as an alternative, each module 210-228 may include one or more hardware devices including electronic circuitry for implementing the functionality described below. In some cases, the modules 210-228 may be implemented as a distributed system across multiple computing devices.

Monitoring module 210 may be configured to monitor elements of a distributed system. Examples of elements of a distributed system include software packages, nodes (e.g., servers, routers, client devices, etc.), etc. Monitoring module 210 may include modules as discussed below for providing functionality to dependency map module 220.

Node interface 212 may communicate with nodes in the distributed system. Specifically, node interface 212 may obtain information such as dependencies between software packages and status information (e.g., availability) from each of the nodes. For example, node interface 212 may access an API exposed by a node to identify dependencies between shared libraries and services installed on the node. In another example, node interface 212 may receive notifications that describe the software packages from the nodes.

Node status module 214 may process status information from the nodes. Status information collected by node interface 212 may be used to track the status (e.g., active, inactive, etc.) of each node in the distributed system. For example, the status of each node may be periodically determined and stored for use by the dependency map module 220. In another example, node status module 214 may monitor the status of each node and then notify dependency map module 220 when a change in status occurs.

Node conditional module 216 may manage conditional rules for the distributed system. For example, if a node becomes inactive, a conditional rule may specify that a substitute software package on another node should be used until the node becomes active again. In another example, a spillover node may be activated when the load of a primary node reaches a preconfigured threshold. Node conditional module 216 may notify dependency map module 220 of changes in the distributed system when conditional rules are triggered.

Dependency map module 220 may process and generate a display of dependency maps of software packages. Although the components of dependency map module 220 are described in detail below, additional details regarding an example implementation of dependency map module 220 are provided above with respect to instructions 122-128 of FIG. 1.

Dependency map managing module 222 may manage dependency maps of software packages. Specifically, dependency map managing module 222 may obtain dependency maps and provide them for use by the other modules of dependency map module 220. For example, dependency maps may be generated and then stored on computing device 200 as a file, database entries, etc. In this example, dependency map module 222 may load a dependency map stored on computing device 200 so that it may be accessed by a user of computing device 200. Dependency map managing module 222 may process the dependency map to determine dependencies of a corresponding software package, where each of the dependencies may be represented in a hierarchy of software packages within a distrusted system. Further, dependency map managing module 222 may also determine status information associated with each of the software packages, where each of the status information may be graphically shown within nodes that represent software packages.

Package dependency module 224 may monitor dependencies and status information of software packages to update dependency maps. For example, notifications of dependency changes from monitoring module 210 may be processed to update dependency maps in storage or in real-time. Package dependency module 224 may also analyze dependencies to identify conflicts for including in renderings of the dependency maps. Examples of conflicts include resource requirement conflicts, a software package preventing another package from initializing properly, a missing referenced package, cyclic dependencies, etc.

Dependency configuration module 226 may manage user configurations of software packages in the context of a dependency map. Specifically, requests from an administrator reviewing a rendered dependency map may be processed to update dependencies in the map. For example, if an administrator sees that a referenced software package is inactive, he may request that an alternative package on a different node be referenced instead. The graphical hierarchy of the dependency map allows the administrator to quickly identify and resolve conflicts between software packages.

Map display module 228 may generate a display of and allow a user to interact with dependency maps. Specifically, the dependency map may be displayed as a graphical hierarchy that is representative of the dependencies between software packages. Further, status information may be represented in package nodes within the hierarchy. Map display module 228 may allow the user to select and modify software packages within the display of the dependency map. Map display module 228 may also be updated to reflect changes in dependencies of the software packages. For example, a software package being inactivated may be detected in real-time and reflected in the dependency map for the administrator's review.

May display module 228 may also allow the user to select and review information for related software packages. For example, if a user selects a referenced or dependent package, map display module 228 may display a dependency map for the selected package.

Generating a display may include directing a graphics device to display the dependency map or generating data that is processed and displayed by a client device. For example, map display module 228 may generate a display of a dependency map by providing instructions to a graphics card for displaying the dependency map on a display device such as a monitor. In another example, map display module 228 may generate display data that is transmitted to and then used by a client device to display the dependency map. In yet another example, computing device 200 may include a graphics processing unit (now shown) that is used by map display module 228 to generate a display of the dependency map.

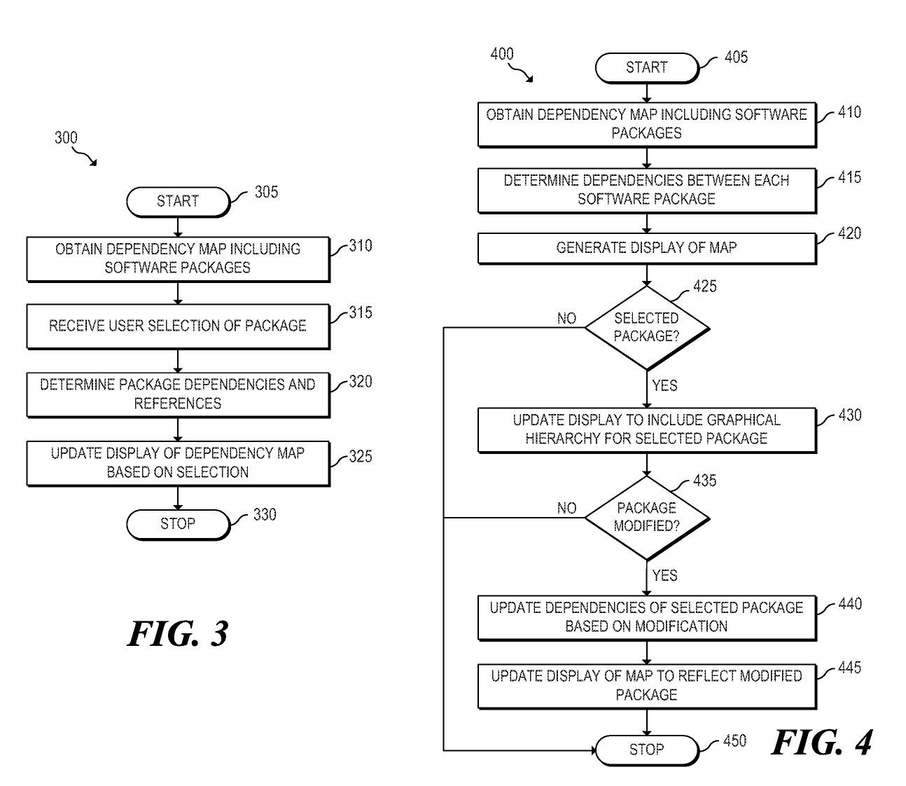

FIG. 3 is a flowchart of an example method 300 for execution by a computing device 100 for providing package dependency maps for distributed computing. Although execution of method 300 is described below with reference to computing device 100 of FIG. 1, other suitable devices for execution of method 300 may be used, such as computing device 200 of FIG. 2. Method 300 may be implemented in the form of executable instructions stored on a machine-readable storage medium, such as storage resource 120, and/or in the form of electronic circuitry.

Method 300 may start in block 305 and continue to block 310, where computing device 100 obtains a dependency map that includes software packages. For example, computing device 100 may consult a lookup table to determine dependencies between software packages. In this example, the dependencies of the software packages in a distributed system may be initially determined and displayed in a textual format for review by an administrator.

In block 315, a user selection of a software package in the distributed system is received. The user selection may also specify a format for rendering a graphical hierarchy for the selected package. Next, in block 320, package dependencies and references are identified for the selected package. In this example, the dependencies and references are the same as shown in the textual display of the dependency map.

In block 325, the display of the dependency map may be updated based on the selection. Specifically, the graphical hierarchy may be rendered on the user interface so that the user can effectively review the dependencies related to the selected software package. Method 300 may subsequently proceed to block 330, where method 300 may stop.

FIG. 4 is a flowchart of an example method 400 for execution by a computing device 200 for displaying and updating a software dependency map for distributed computing. Although execution of method 400 is described below with reference to computing device 200 of FIG. 2, other suitable devices for execution of method 400 may be used, such as computing device 100 of FIG. 1. Method 400 may be implemented in the form of executable instructions stored on a machine-readable storage medium and/or in the form of electronic circuitry.

Method 400 may start in block 405 and proceed to block 410, where computing device 200 obtains a dependency map that includes software packages for a distributed system. In block 415, dependencies between each of the software packages may be determined and, for example, prepared for a textual format. In block 420, a display of the textual format of the dependency map is generated and displayed in a table that includes a row for each software package.

In block 425, computing device 200 determines if a package has been selected by the administrator. If a package is not selected, method 400 may proceed to block 450 and stop. If a package is selected, computing device 200 updates the display to include a graphical hierarchy for the selected package in block 430. The administrator may change the graphical hierarchy presented by selecting different packages from the list of packages shown in the table.

In block 435, computing device 200 determines if a package has been modified. If a package is not modified, method 400 may proceed to block 450 and stop. If a package is modified, the dependencies of the selected package are updated based on the modification in block 440. For example, the administrator may add or remove referenced packages of the selected package. In this example, the dependency requirements (i.e., referenced and dependent packages) of each of the modified referenced packages are verified to ensure that no conflicts have been introduced by the modification. In block 445, the display of the dependency map is updated to reflect the modified package. In this example, the referenced packages may be updated to include new referenced packages added by the administrator. Method 400 may subsequently proceed to block 450, where method 400 may stop.

FIG. 5 is a block diagram of an example user interface 500 for displaying a software dependency map for distributed computing. As depicted, the user interface 500 includes a title bar 505 identifying the dependency map and a close icon 510 that may be used by the user to exit the application. The user interface 500 also includes navigation components: a back button 515, a forward button 520, a packages button 525, a nodes button 530, and a sites button 535. As shown in FIG. 5, the packages button 525 may be used to navigate to a display of the current software packages loaded in the application. The nodes button 530 may be used to navigate to a list of nodes in the distributed system. A node may be selected from the list to load a display of the software packages installed on the selected node. The sites button 535 may be used to navigate to a list of sites of the distributed system. A site may be selected from the list to load a display of the software packages installed at the selected site. A site may be a physical location where one or more of the nodes of the distributed system are located.

The current package of interest 537 is shown with an add dependencies button 539 for adding additional dependent packages of the current package 537. Dependent packages of the current package 537 are shown in a table with a package name column 540, a node column 545, a status column 550, a dependent packages column 555, a referenced packages column 560, and an actions column 565. The table includes rows for each of the dependent packages of the current package 537, where a package row 575 and a selected package row 580 are shown. Each of the package rows 575, 580 includes a close button 577 and an add dependent package button 579. Selecting the close button 577 removes the corresponding package as a dependent package from the current package 537. Selecting the add dependent package button 579 adds a dependent package to the corresponding package. The user interface 500 also includes a scroll bar for 570 for browsing the list of package rows 575, 580. In this example, an alert 582 is shown for package 6 because it has a cyclic dependency. Specifically, package 6 both references and depends on package 7, which may tightly couple the packages such that they can no longer be used independently. The selected package row 580 shows information for package 3 585, which is displayed in the rendered graphical hierarchy.

The hierarchy for package 3 585 includes dependency edges 597 and package nodes 590. Each of the package nodes 590 corresponds to a package in the distributed system and includes a status indicator 595 that shows the current status of the package. The dependency edges 597 show dependencies with the dependent and referenced packages of package 3 585 as also shown in the selected package row 580.

The foregoing disclosure describes a number of example embodiments for dependency maps for distributed computing. In this manner, the embodiments disclosed herein enable administrators to rapidly assess package dependencies to identify and resolve conflicts by providing a graphical hierarchy of the dependencies.

We claim:

1. A system for providing package dependency maps for distributed computing, the system comprising:
a processor to:
obtain a dependency map comprising a plurality of software packages, wherein each of the plurality of software packages is associated with one of a plurality of sites and one of a plurality of distributed nodes;
in response to a user selection of a target package of the plurality of software packages in the dependency map, determine a referenced subset of the plurality of software packages on which the target package depends and a dependent subset of the plurality of software packages that depend on the target package; and
update a display of the dependency map that comprises the target package, the referenced subset, and the dependent subset in a graphical hierarchy.

2. The system of claim 1, wherein the processor is further to:
detect a modification of a modified package of the plurality of software packages; and
modify the display of the dependency map based on the modification.

3. The system of claim 2, wherein the modification is an availability status of the modified package, and wherein the dependency map shows that a failover package of the plurality of software packages is activated at a backup node of the plurality of distributed nodes in response to the modification.

4. The system of claim 1, wherein the processor is further to:
receive a reconfiguration request for the target package of the plurality of software packages; and
in response to the reconfiguration request, determine that the reconfiguration request does not violate dependency requirements of the referenced subset and the dependent subset.

5. The system of claim 1, wherein the graphical hierarchy comprises a package node for each of the plurality of software packages and a plurality of dependency edges to connect the target package to the referenced subset and the dependent subset.

6. The system of claim 5, wherein the display of the dependency map further comprises a status indicator for each of the plurality of software packages that describes a status of a corresponding package.

7. A method for providing package dependency maps for distributed computing, the method comprising:
obtaining a dependency map comprising a plurality of software packages, wherein each of the plurality of software packages is associated with one of a plurality of sites and one of a plurality of distributed nodes;
in response to a user selection of a target package of the plurality of software packages in the dependency map, determining a referenced subset of the plurality of software packages on which the target package depends and a dependent subset of the plurality of software packages that depend on the target package; and
updating a display of the dependency map that comprises the target package, the referenced subset, and the dependent subset in a graphical hierarchy, wherein the graphical hierarchy comprises a package node for each of the plurality of software packages and a plurality of dependency edges to connect the target package to the referenced subset and the dependent subset.

8. The method of claim 7, further comprising:
detecting a modification of a modified package of the plurality of software packages; and
modifying the display of the dependency map based on the modification.

9. The method of claim 8, wherein the modification is an availability status of the modified package, and wherein the dependency map shows that a failover package of the plurality of software packages is activated at a backup node of the plurality of distributed nodes in response to the modification.

10. The method of claim 7, further comprising:
receiving a reconfiguration request for the target package of he plurality of software packages; and
in response to the reconfiguration request, determining that the reconfiguration request does not violate dependency requirements of the referenced subset and the dependent subset.

11. The method of claim 7, wherein the display of the dependency map further comprises a status indicator for each of the plurality of software packages that describes a status of a corresponding package.

12. A non-transitory machine-readable storage medium encoded with instructions executable by a processor for providing package dependency maps for distributed computing, the machine-readable storage medium comprising instructions to:
obtain a dependency map comprising a plurality of software packages, wherein each of the plurality of software packages is associated with one of a plurality of sites and one of a plurality of distributed nodes;
in response to a user selection of a target package of the plurality of software packages in the dependency map, determine a referenced subset of the plurality of software packages on which the target package depends and a dependent subset of the plurality of software packages that depend on the target package;
update a display of the dependency map that comprises the target package, the referenced subset, and the dependent subset in a graphical hierarchy;
receive a reconfiguration request for the target package of the plurality of software packages; and
in response to the reconfiguration request, determine that the reconfiguration request does riot violate dependency requirements of the referenced subset and the dependent subset.

13. The non-transitory machine-readable storage medium of claim 12, wherein the instructions are further to:
detect a modification of a modified package of the plurality of software packages; and
modify the display of the dependency map based on the modification.

14. The non-transitory machine-readable storage medium of claim 13, wherein the modification is an availability status of the modified package, and wherein the dependency map shows that a failover package of the plurality of software packages is activated at a backup node of the plurality of distributed nodes in response to the modification.

15. The non-transitory machine-readable storage medium of claim 12, wherein the graphical hierarchy comprises a package node for each of the plurality of software packages and a plurality of dependency edges to connect the target package to the referenced subset and the dependent subset.
